(19) United States
(12) Patent Application Publication
(10) Pub. No.: US 2019/0259237 A1
(43) Pub. Date: Aug. 22, 2019

(54) TOKEN OPERATED ACCESS CONTROL SYSTEM

(71) Applicant: LockNet, LLC, Nicholasville, KY (US)

(72) Inventor: Benson L. Miller, Lexington, KY (US)

(21) Appl. No.: 16/401,694

(22) Filed: May 2, 2019

Related U.S. Application Data
(63) Continuation of application No. 11/566,795, filed on Dec. 5, 2006, now abandoned.
(60) Provisional application No. 60/742,836, filed on Dec. 6, 2005.

(51) Int. Cl. G07F 17/14

(52) U.S. Cl. CPC G07F 17/14

(57) ABSTRACT

A token operated access control system is provided for a door to control access to a secured area through the door. The token operated access control system includes an electrically-operated door lock or strike that is actuated by a token operated actuator. The token operated actuator includes a token validator for distinguishing between a valid token and an invalid token introduced into the token validator. The token operated actuator is operable to actuate the door lock or strike in response to a valid token introduced into the token validator.

The present application is a Continuation application of U.S. Ser. No. 14/566,795, filed Dec. 5, 2006, which claims the filing benefit of U.S. Provisional Application Ser. No. 60/742,836, filed Dec. 6, 2005, the disclosures of which are incorporated herein by reference in their entireties.

### FIELD OF THE INVENTION

The present invention relates generally to access control systems and, more particularly, to such systems used in combination with a door to prevent unauthorized access to a secured area through the door.

### BACKGROUND OF THE INVENTION

Controlling access to public restrooms in restaurants, gas stations, and other public facilities is often required to prevent unauthorized use. In certain areas, drug users and homeless people will use public restrooms for illegal drug use, bathing, warming up, or other undesirable activities that the facility managers want to prevent. The managers need to prevent such unauthorized use while allowing restroom access to their customers.

The typical method used to secure and control access to restrooms is through the use of a key operated lock on the entrance door to the restroom. The restroom doors remains locked at all times and requires a key to be opened. To use the restroom, a customer must obtain a key from the manager that unlocks the restroom door. The customer then returns the key to the manager after use of the restroom. Unauthorized use of the restroom is prevented by the manager controlling use of the key.

While this method does prevent unauthorized use, there are inherent problems that make the use key operated locks on restroom doors undesirable. For example, customers will not always return the key after using the restroom so that the manager is required to purchase replacement keys. The cost of replacement keys and the “lost” time used to obtain them can become quite expensive for the manager. Also, customers accidentally lock the keys in the restroom which results in the manager having to call in a locksmith to open the door. In this situation, or when all of the keys have been lost, the lock is usually replaced resulting in a very expensive repair cost. Thus, the expense of replacing keys and locks make key operated locks undesirable for controlling restroom access.

Another type of lock used to secure restrooms is a push-button code lock. To use the restroom, a customer must obtain the access code (usually four to six digits) from the manager. The customer then enters the code into the lock on the restroom door to gain access. An advantage of a code lock over a key lock is the elimination of the cost of replacement keys and locks due to lost keys because it is not necessary for the customer to return a key. But, there are also problems that make the use of code locks on restroom doors undesirable. For example, the procedure to change the code for code locks is somewhat complicated and therefore the code is seldom changed. It is very easy for customers to pass the code on to others, which often results in the code falling into the hands of unauthorized users. Once a person knows the code, they can use the restroom at any time without getting authorization from the manager. Thus, controlled restroom access is compromised due to the difficulty of changing the lock code and the ease of passing the code to unauthorized users.

Another type of lock used to secure restrooms is a mechanical token operated lock. To use this type of lock, the customer must first obtain a token from the manager. The token is then deposited into the lock to unlock the restroom door and the lock accumulates the used tokens. The manager then recycles the tokens by removing them from the lock as required. The advantage of a token lock over a key lock is the elimination of the cost of replacement keys and locks due to lost keys. The advantage of a token lock over a code lock is the elimination of the need to change codes. And, because the tokens are “captured” by the lock as they are used, customers cannot pass a code on to others and must always obtain a token from the manager for bathroom access. But, there are also problems that make the use of mechanical token locks undesirable for bathroom doors. In particular, the customer is required to use two hands to exit the bathroom. One hand is used to rotate a knob of the lock, and the other hand is used to rotate a handle to unlatch the door. Because the customer is required to use two hands to exit, typical mechanical token locks do not meet the American with Disabilities Act requirement for one-handed egress from locked rooms.

Yet another locking method used to secure restrooms is a remote activated electronic lock or strike that is opened remotely by the manager. When a customer is authorized to use the restroom, the manager pushes a remote button, normally located behind the customer counter, that “buzzes” or unlocks the door for several seconds which allows customer access. The remote activated electronic lock has the same advantages of the mechanical token lock in that there are no keys to replace and there is no code that can easily be passed on to unauthorized users. But, a problem with a remote activated electronic lock is that the manager must have clear line-of-sight visibility from the remote button to the restroom to be certain the authorized customer is standing at the restroom door when the button is pushed to unlock the door. Very often the restrooms are in a hallway that is not visible from the customer counter. A remote operated lock also requires more time by the manager since the manager must wait until the customer is at the bathroom door before pushing the button to unlock the door.

There are several different types of electronic locks and strikes available today that can be used to secure and control access to a room, such as a public restrooms. But, they all require some type of electronic “key” such as a magnetic strip card, a proximity card, or a remote pushbutton. Therefore, the electronic locks available today have the same disadvantages of mechanical key locks.

Therefore, there is a need for an access control system to control access to public restrooms or other secure areas that does not require the expense of replacement keys. There is also a need for an access control system that does not utilize a code that can easily be passed on to unauthorized users. There is yet also a need for an access control system that does not require much time from the manager to operate or administer and is compliant with the American with Disabilities Act.

### SUMMARY OF THE INVENTION

The present invention overcomes the foregoing and other shortcomings and drawbacks of access control systems heretofore known for use in combination with a door to prevent unauthorized access to a secured area through the door. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a token operated access control system is provided for a door to control access to a secured area through the door. In one embodiment, the access control system includes an electrically-operated door lock having a locked state in which the door is secured and an unlocked state in which the door is unsecured. A token operated actuator is electrically coupled to the door lock. The token operated actuator includes a token validator that is able to distinguish between a valid token and an invalid token introduced into the token validator. The token operated actuator is operable to unlock the door lock in response to a valid token introduced by a customer into the token validator. The access control system includes a timer to relock the door lock after a predetermined period of time so that the door lock remains locked until a customer introduces a valid token into the token validator. Valid tokens are collected by the access control system so that they may be reused by the establishment for customers who desire to use the restroom. Invalid tokens are returned to the customer.

In accordance with another embodiment of the present invention, the token operated access control system includes an electrically-operated strike having a latching state in which the door is secured and an unlatching state in which the door is unsecured. A token operated actuator is electrically coupled to the strike and is operable to unlatch the door in response to a valid token introduced by a customer into the token validator. The access control system includes a timer to relatch the door lock after a predetermined period of time so that the door remains latched until a customer introduces a valid token into the token validator.

In one embodiment, the token validator has a token input for receiving a token and a valid token output and an invalid token output in communication with the token input. The actuator includes a switch positioned in alignment with the valid token output. The switch is actuatable by a valid token exiting the valid token output. In response to actutation of the switch by the valid token, the actuator is operable to cause the door lock to unlock or the strike to unlatch the door to provide a customer access to the secured area through the door.

There are several advantages of using a token operated access control system for controlling restroom access. The cost of replacement tokens is significantly less than the replacement cost of keys, reducing the operating cost of the access control system. The tokens are captured by the access control system as they are used and there is no code that can be passed on to unauthorized users which improves access control. The manager does not need line-of-sight to the restroom and can quickly hand a token to an authorized customer which simplifies administration. Moreover, the token operated access control system of the present invention is compliant with the American with Disabilities Act.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of an access control system for a door in accordance with one embodiment of the present invention;

FIG. 2 is a view similar to FIG. 1, showing the access control system opened and partially disassembled;

FIG. 3 is a side elevational view, partially in cross-section, of the access control system shown in FIG. 1;

FIG. 4 is a view similar to FIG. 2, showing assembly of the access control system;

FIG. 5 is a perspective view of an access control system for a door in accordance with another embodiment of the present invention;

FIG. 6A-6D are diagrammatic views showing operation of an electrically-operated door strike in the access control system of FIG. 5;

FIG. 7 is a diagrammatic perspective view of an exemplary token validator for use in the access control system of the present invention;

FIGS. 8A and 8B are functional block diagrams of the access control system shown in FIG. 1; and

FIG. 8 C is a functional block diagram of the access control system shown in FIG. 5.

### DETAILED DESCRIPTION OF THE PREFERRED EMBODIMENT

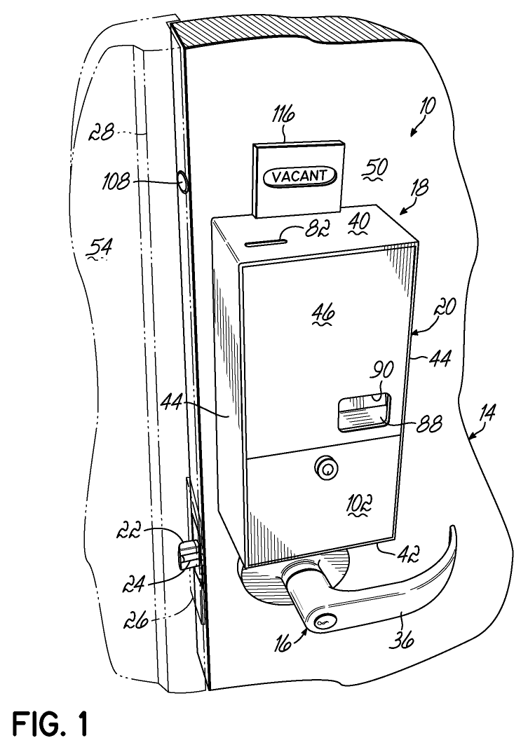

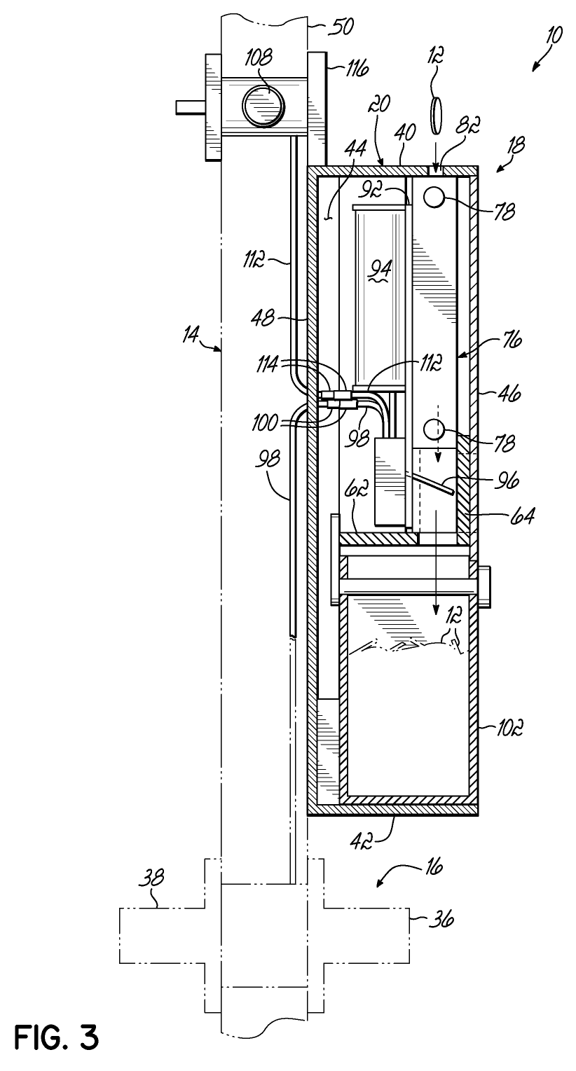

Referring now to the figures, and to FIGS. 1-4 in particular, an access control system 10 is shown in accordance with one embodiment of the present invention. As will be described in greater detail below, access control system 10 is designed to be operated by a token 12 (FIG. 3) and is particularly adapted to prevent unauthorized access to a secured area through a door 14, such as a public bathroom or other restricted area. As used herein, it will be understood that “token” is intended to mean a coin, disc or other object that generally has a regular shape such as circular, square, hexagonal, octagonal, triangular or other generally regular shape and is often made by molding, punching, stamping or otherwise forming a material such as plastic, metal or other suitable material. A token may have indicia applied thereto; and a specific size, shape, material and indicia of a token are generally chosen as a function of application requirements relating to use, manufacturing costs, durability, security, comparable currency value, if any, and other application considerations. While the access control system 10 will be described herein in connection with controlling access to a public restroom through a door 14 by way of example, it will be appreciated that the access control system 10 of the present invention may be utilized for controlling access to other secured areas as well without departing from the spirit and scope of the present invention.

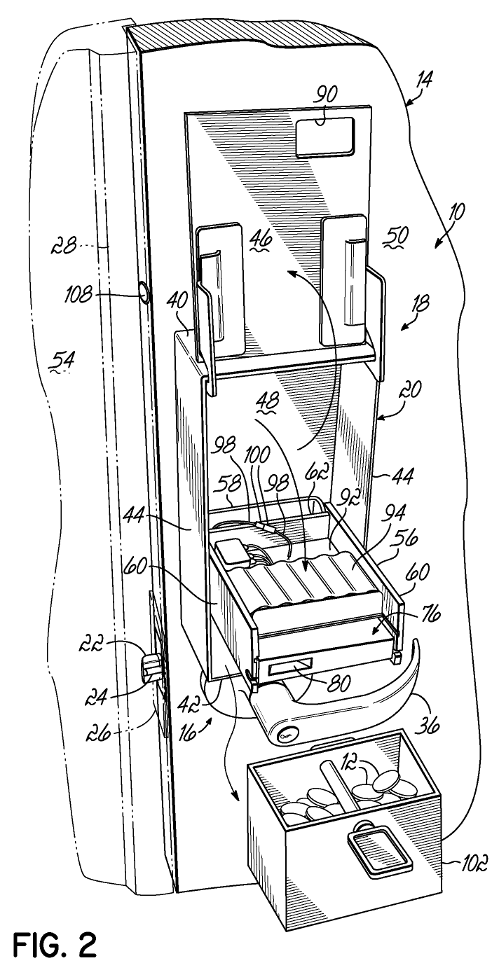

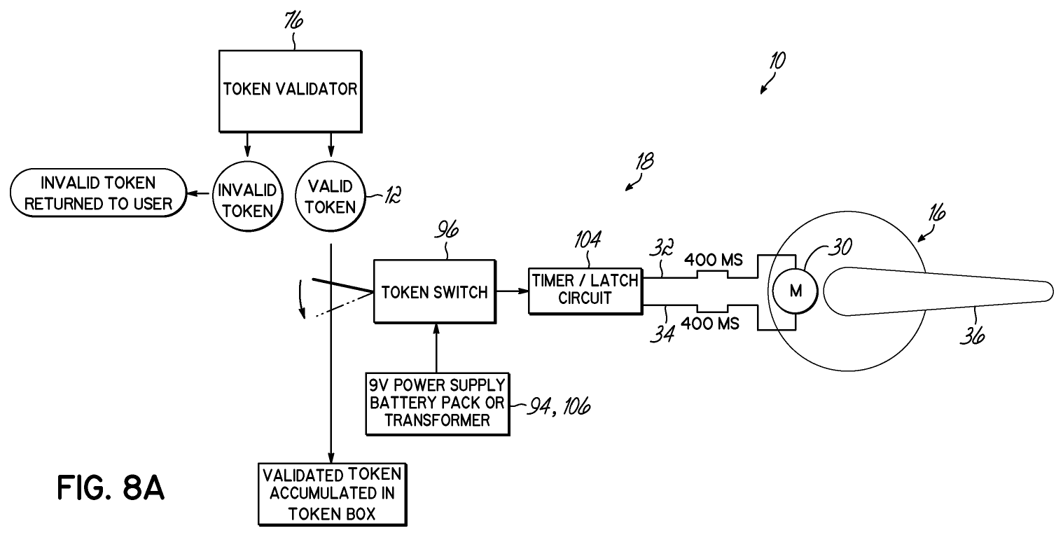

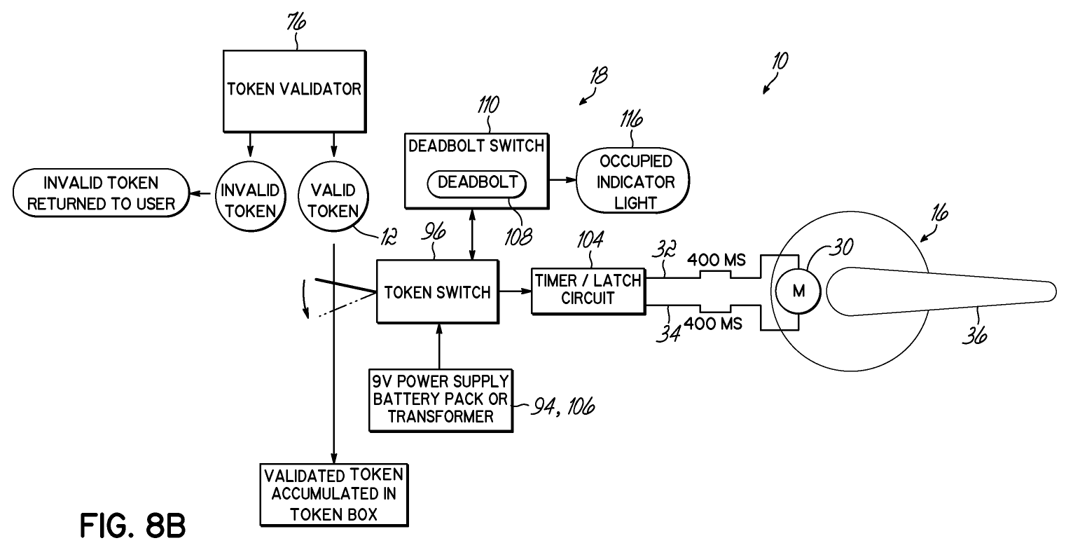

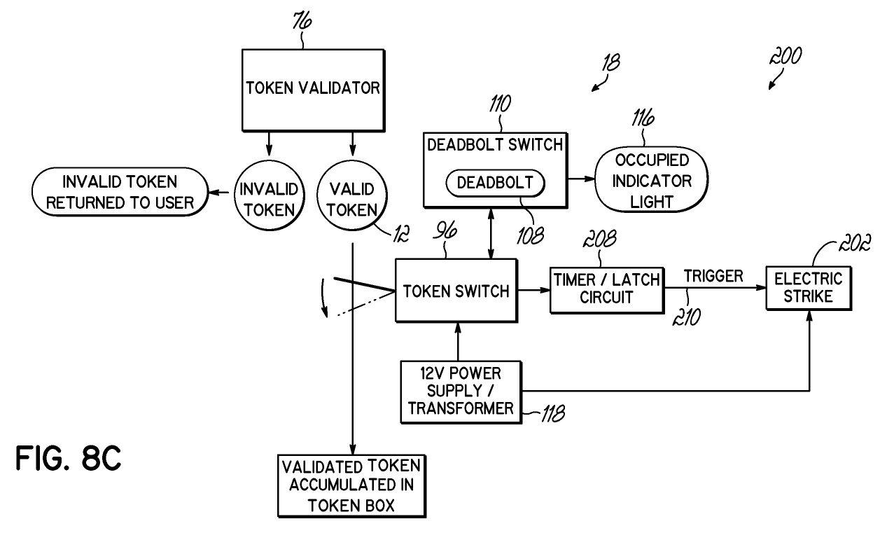

In one embodiment of the present invention as shown in FIGS. 1-4, the access control system 10 includes an electrically-operated door lock 16 mounted on the door 14 and a token operated actuator 18 (FIGS. 2-4) supported in a housing 20 and electrically coupled to the door lock 16. The door lock 16 may have a spring latch 22 and a dead latch pin 24 as shown in FIGS. 1-2 that cooperate with a strike plate 26 provided on a door jamb 28 to secure the door 14 when the door is locked. One door lock suitable for use in the present invention is the Model 5491LN cylindrical lockset commercially available from Yale of Norcross, Ga. which has an internal pulse motor 30 (FIGS. 8A and 8B) for setting the door lock 16 in locked and unlocked states in response to electrical signals applied to the door lock 16. Other electrically-operated door locks are possible as well without departing from the spirit and scope of the present invention.

In one embodiment of the present invention as shown in FIGS. 8A and 8B, the door lock 16 is unlocked when a positive pulse 32 is applied by the actuator 18 to the door lock 16 for approximately 400 ms. The door lock 16 is relocked when a negative pulse 34 is applied by the actuator 18 to the door lock 16 for approximately 400 ms. In the locked state, the outside lever 36 (FIGS. 1-3 and 8A-8B) will not turn to unlatch the door 14 so that the door 14 cannot be opened without the use of a token 12 as described in detail below. The inside lever 38 (FIG. 3) is always active so that the door 14 can always be opened from the inside by a customer. The door lock 16 can be opened with a mechanical key (not shown) from the outside of the door 14 if there is an electrical failure.

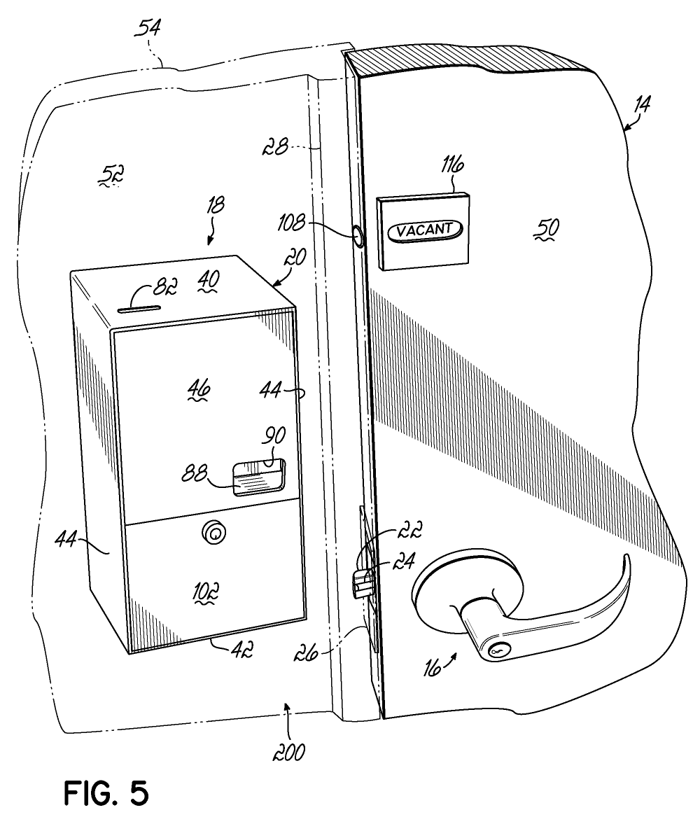

Further referring to FIGS. 1-4, the housing 20 may be made of stainless steel or other suitable rugged material and has a top wall 40, a bottom wall 42, a pair of opposite side walls 44, a front wall 46 and a rear wall 48. The front wall 46 is pivotally connected to the side walls 44 through a pair of pivot connections (not shown) so that the front wall 46 is pivotal between a closed position as shown in FIGS. 1 and 3, and an open position as shown in FIG. 2. The housing 20 is configured to be rigidly and securely mounted to an outside surface 50 of the door 14 through suitable mounting hardware (not shown) as shown in FIGS. 1-4 or, alternatively, to an outside surface 52 of a wall 54 adjacent the door 14 as shown in FIG. 5 as will be described in greater detail below.

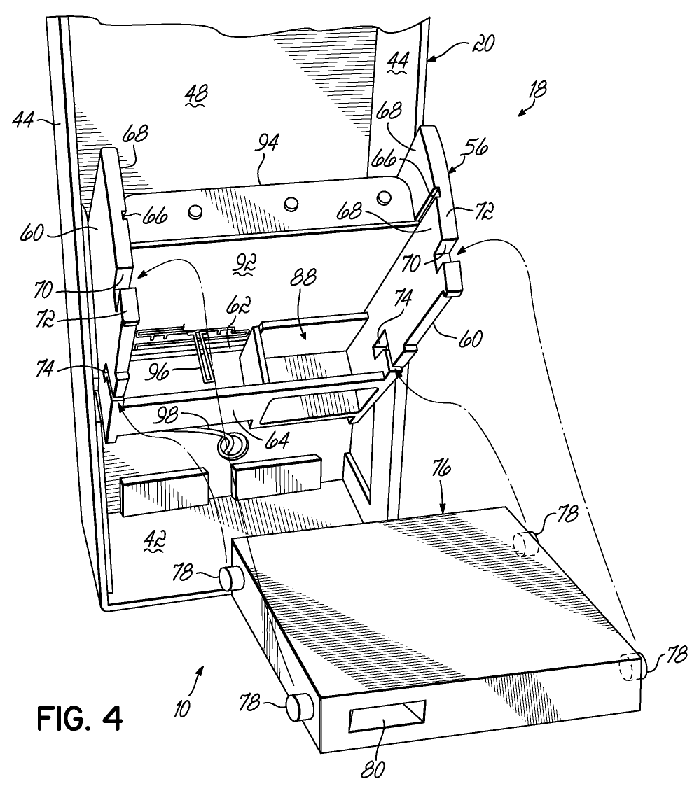

As shown in FIGS. 2-4, a bracket 56 is pivotally mounted to a bracket support 58 (FIG. 2) within the housing 20 through a pair of pivot connections (not shown) provided at a lower end of the bracket 56. The bracket 56 may be pivotal between a generally horizontal position as shown in FIG. 2 to permit installation, repair or replacement of various components of the actuator 18 as described in detail below, and a generally vertical position as shown in FIG. 3 when the housing 20 is closed. In one embodiment, the bracket 56 is made of metal or other suitable material and is formed by a pair of opposite side walls 60, a bottom wall 62 and a front wall 64. A pair of elongated slots 66 (FIG. 4) are formed on inner surfaces 68 of the side walls 60 to slidably receive one component of the actuator 18 adjacent a rear side of the bracket 56 as described in detail below.

Further referring to FIGS. 2-4, the bracket 56 also includes a pair of notches 70 formed on upper edges 72 of the bracket side walls 60 and a pair of J-shaped notches 74 formed in the pair of side walls 60. The notches 70 and 74 are provided for removably supporting a token validator 76 forming another component of the actuator 18 as described in detail below. In one embodiment, the token validator 76 is a Model V9 token validator commercially available from Imonex of Katy, Tex., although other token validators are possible as well. As shown in FIGS. 3, 4 and 7, the token validator 76 may have a pair of lugs 78 provided on each side of the token validator 76 which are received in the respective notches 70 and 74 formed in the bracket 56. The lugs 78 cooperate with the notches 70 and 74 so that the token validator 76 is easily installable and removable adjacent a front side of the bracket 56.

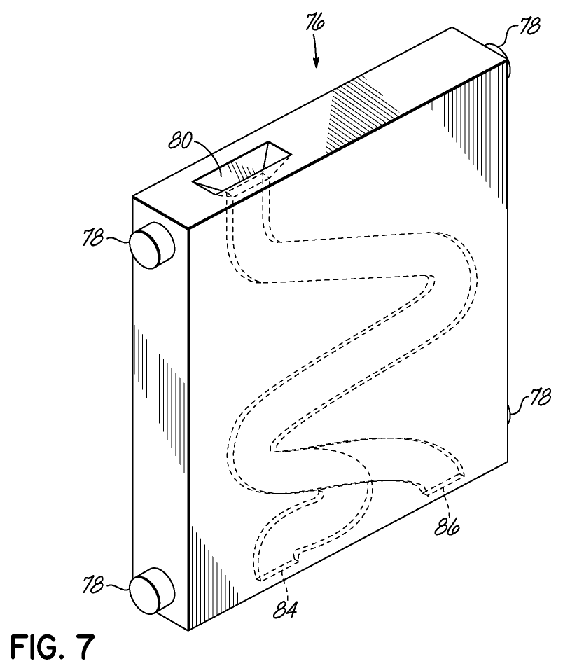

As shown diagrammatically in FIGS. 2, 4 and 7, the token validator 76 has a token input 80 for receiving a token 12 (FIG. 3) introduced into the token validator 76. In one embodiment, the housing 20 has a slot 82 formed in the top wall 40 thereof that is aligned with the token input 80 of the token validator 76 when the token validator 76 is installed in the bracket 56 and the bracket 56 is positioned in the generally vertical position as shown in FIG. 3. As those of ordinary skill in the art will appreciate, the token validator 76 has a valid token output 84 and an invalid token output 86 in communication with the token input 80 as shown in FIG. 7. The token validator 76 is operable to distinguish between a valid token and an invalid token introduced into the token validator 76 as the token passes through the token validator 76. Valid tokens exit the valid token output 84 of the token validator 76 while invalid tokens exit the invalid token exit output 86. It will be appreciated that other types and configurations of token validators and token discriminators known in the art are possible as well without departing from the spirit and scope of the present invention.

In one embodiment, the bracket 56 includes an integral token return 88 that is aligned with the invalid token output 86 of the token validator 76. The front wall 46 of the housing 20 includes an opening 90 that provides a customer access to invalid tokens directed to the token return 88. When an invalid token is introduced into the token validator 76, the invalid token passes through the token validator 76 and exits the invalid token output 86 where it is deposited into the token return 88.

In one embodiment of the present invention, as shown in FIGS. 3, 4, 8A and 8B, the actuator 18 includes a circuit board 92 that supports a battery pack 94, various electronic components (not shown) and a switch 96 that extends forwardly through an opening formed in the circuit board 92. The battery pack 94 may be a 9-volt battery pack that houses six 1.5-volt AA alkaline batteries. Opposite side edges of the circuit board 92 are captured and guided in the elongated slots 66 formed in the side walls 60 of the bracket 56 so that the switch 96 is positioned adjacent the valid token output 84 of the token validator 76. The circuit board 92 of the actuator 18 is electrically coupled to the electrically-operated door lock 16 through electrical leads 98 and connectors 100. In this way, the circuit board 92 of the actuator 18 is easily installable and removable adjacent the rear side of the bracket 56 and the connectors 100 provide easy electrical connection and disconnection of the circuit board 92 with the electrically-operated door lock 16.

Referring now to FIGS. 3 and 8A, operation of the access control system 10 will be described according to one embodiment for unlocking the door lock 16 with a valid token inserted by a customer into the token validator 76. When a customer desires access to the restroom, the customer inserts a token 12 through the opening 82 in the top wall 40 of the housing 20. The token 12 is introduced into the token validator 76 through the token input 80 in alignment with the opening 82 and is distinguished by the token validator 76 as being either a valid token or an invalid token.

In the event the token 12 is valid, the valid token 12 exits the valid token output 84 of the token validator 76 and strikes and actuates the switch 96 of the actuator 18. Thereafter, the valid token 12 is deposited into a removable and lockable token collection box 102 (FIGS. 1-3) supported in the housing 20. The collection box 102 stores and collects valid tokens so that they may be reused by the establishment for customers who desire to use the restroom.

Actuation of the switch 96 by the falling valid token 12 energizes a timer and latch circuit 104 to apply a positive 9 volt, 0.046 A pulse 32 to the door lock 16 for approximately 400 milliseconds which unlocks the door lock 16. The timer 104 then counts down for approximately six seconds to provide the customer adequate time to open the door 14 after inserting the token 12. When the count down of the timer 104 is completed, a negative 9-volt, 0.046 A pulse 34 is applied to the door lock 16 for approximately 400 milliseconds which re-locks the door lock 16. The circuit then goes into a low power consumption standby mode to maximize the life of the batteries 94.

When the customer is ready to leave the restroom, the customer turns the inside lever 38 (FIG. 3) to open the door 14. When the door 14 closes, the door lock 16 remains locked until another customer introduces a valid token 12 into the token validator 76.

While a switch 96 is shown and described in one embodiment, it will be appreciated that other types of electrical, mechanical, electro-mechanical, optical or other suitable actuatable switches are possible as well without departing from the spirit and scope of the present invention. Also, while the switch 96 is described in one embodiment as being positioned adjacent the valid token output 84, it is contemplated that the switch 96 may be placed at other locations as well so as to be actuatable by a valid token.

In another embodiment of the access control system 10, the housing 20 is mounted on a wall 54 adjacent the door 14 and the actuator 18 is electrically coupled (i.e., hard-wired) to a transformer 106 (FIGS. 8A and 8B). In this embodiment, the battery pack 94 is not required and the circuit board 92 of the actuator 18 is electrically coupled to the transformer 106 through suitable electrical leads and connectors (not shown).

In one embodiment as shown in FIGS. 1, 3 and 8B, the access control system 10 includes an “occupied” indicator deadbolt 108 that may be actuated by the customer after the customer enters the restroom. The indicator deadbolt 108 includes a deadbolt switch 110 (FIG. 8B) that is electrically coupled to the switch 96 through electrical leads 112 and connectors 114.

When the indicator deadbolt 108 is unlocked as shown in FIGS. 1-3, the switch 96 is enabled so as to be actuatable by a valid token 12 to unlock the door lock 16. When the deadbolt 108 is locked, the switch 96 is disabled so as not to be actuatable by a valid token 12. This prevents inadvertent opening of the door 14 when a customer outside of the restroom inserts a valid token 12 into the housing 20 while another customer is using the restroom. Also, when the deadbolt 108 is locked, an indicator 116 is energized, such as an “occupied” light or other suitable indicator, to provide a visual indication to a customer outside of the restroom that the restroom is occupied.

Referring now to FIGS. 5, 6A-6D and 8C, an access control system 200 in accordance with an alternative embodiment of the present invention is shown, where like numerals represent like parts to the access control system 10. In this embodiment, the access control system 200 includes an electrically-operated strike 202 mounted in the door jamb 28. One electrically-operated strike suitable for use in the present invention is the Model UNL-12 electric strike commercially available from Securitron Magnalock Corp. of Sparks, Nev. Other electric strikes are possible as well without departing from the spirit and scope of the present invention.

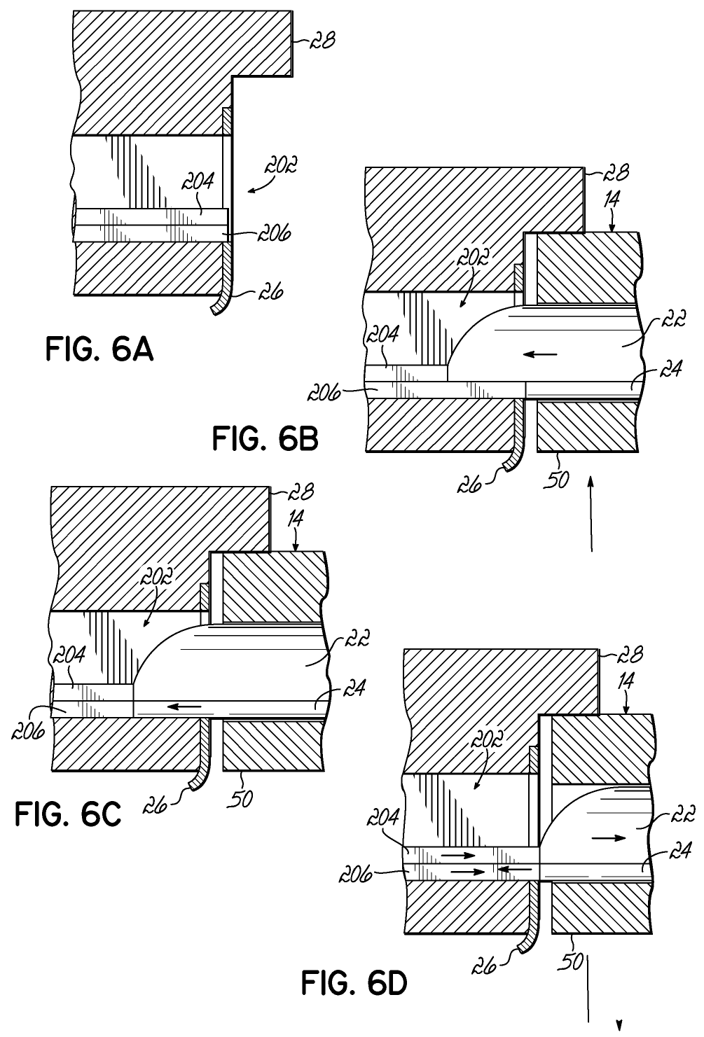

In this embodiment, the housing 20 is mounted on a wall 54 adjacent the door 14 and the token operated actuator 18 is electrically coupled (i.e., hard-wired) to a transformer 118 (FIG. 8C). The actuator 18 is electrically coupled to the strike 202 through electrical leads and connectors (not shown) and is operable to transition the strike 202 from a latching state in which the door 14 is secured (FIG. 6B) to an unlatching state in which the door 14 is unsecured (FIG. 6D).

Referring now to FIGS. 6A-6D and 8C, operation of the access control system 200 will be described according to one embodiment for unlatching the door 14 with a valid token 12. As shown in FIG. 6A, the strike 202 includes a spring latch plunger 204 and a dead latch plunger 206 that are extended and ready to accept the spring latch 22 and dead latch pin 24 of the door 14. When the door 14 is in the closed and secured position (i.e., latched) as shown in FIG. 6B, the spring latch 22 of the door 14 pushes in the spring latch plunger 204 of the strike 202 so that the spring latch 22 is captured and the dead latch pin 24 rests on the dead latch plunger 206 which pushes in the dead latch pin 24 to secure the door 14.

When a customer desires access to the restroom, the customer inserts a token 12 through the opening 82 in the top wall 40 of the housing 20. The token 12 is introduced into the token validator 76 through the token input 80 in alignment with the opening 82 and is distinguished by the token validator 76 as being either a valid token or an invalid token.

In the event the token 12 is valid, the valid token 12 exits the valid token output 84 of the token validator 76 and strikes and actuates the switch 96 of the actuator 18. Thereafter, the valid token 12 is deposited into the removable and lockable token collection box 102 supported in the housing 20.

Actuation of the switch 96 by the falling valid token 12 energizes a timer and latch circuit 208 to apply a trigger signal 20 to the strike 202 which unlatches the door 14. As shown in FIG. 6C, the trigger signal 202 causes the dead latch plunger 206 to retract which allows the dead latch pin 24 to move out. Thereafter, as shown in FIG. 6D, both the spring latch plunger 204 and the dead latch plunger 206 push the spring latch 22 and dead latch pin 24 to unlatch the door 14. After a six second countdown by the timer 208, the trigger signal 210 is disconnected from the strike 202 and the door is secured (i.e., latched). When the customer is ready to leave the restroom, the customer turns the inside lever 38 (FIG. 3) to unlatch and open the door 14. When the door 14 closes, the door 14 remains latched until another customer introduces a valid token 12 into the token validator 76.

While the present invention has been illustrated by the description of an exemplary embodiment thereof, and while the embodiment has been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A token operated access control system for a door to control access to a secured area through the door, comprising:
an electrically-operated access control device having a first state in which the door is secured and a second state in which the door is unsecured, the access control device comprising one of an electrically-operated door lock or an electrically-operated strike; and
a token operated actuator electrically coupled to the access control device, with the access control device being located externally of the token operated actuator, the actuator having a token validator including a token input for receiving a token and a valid token output and a separate single invalid token output both in communication with the token input, the token validator being configured to distinguish between, and separate, a valid token and an invalid token introduced into the token input of the token validator and passing through the token validator, the actuator including an actuating device positioned in alignment with the valid token output, with the actuator being operable to automatically transition the access control device from the first state to the second state in response to an electrical signal generated by the actuator resulting from a valid token introduced into the token input of the token validator and detected by the actuating device.

2. The token operated access control system of claim 1, wherein the electrically-operated door lock has a locked state in which the door is secured and an unlocked state in which the door is unsecured.

3. The token operated access control system of claim 2, wherein the door lock comprises an electrically-operated cylindrical lockset.

4. The token operated access control system of claim 2, wherein the actuator is electrically coupled to the door lock, the actuator being operable to transition the door lock from the locked state to the unlocked state in response to a valid token introduced into the token validator.

5. The token operated access control system of claim 1, wherein the actuator further comprises a switch positioned in alignment with the valid token output, the switch being actuatable by a valid token exiting the valid token output.

6. The token operated access control system of claim 5, wherein the actuator is operable to transition the door lock from the locked state to the unlocked state in response to actuation of the switch by a valid token exiting the valid token output.

7. The token operated access control system of claim 2, wherein the actuator further comprises a battery for supplying power to the door lock to transition the door lock between the locked and unlocked states.

8. The token operated access control system of claim 2 further comprising a transformer coupled to the actuator for supplying power to the door lock to transition the door lock between the locked and unlocked states.

9. The token operated access control system of claim 5 further comprising an indicator deadbolt operatively connected to the switch, the indicator deadbolt being movable to a first position in which the switch is enabled so as to be actuatable by a valid token exiting the valid token output to transition the door lock from the locked state to the unlocked state and a second position in which the switch is disabled so as not to be actuatable by a valid token exiting the valid token output.

10. The token operated access control system of claim 9 further comprising an indicator operatively connected to the indicator deadbolt, the indicator being operable to provide a visual indication when the indicator deadbolt is moved to the second position.

11. The token operated access control system of claim 1, wherein the electrically-operated strike has a latching state in which the door is secured and an unlatching state in which the door is unsecured.

12. The token operated access control system of claim 11, wherein the actuator is electrically coupled to the strike, the actuator being operable to transition the strike from the latching state to the unlatching state in response to a valid token introduced into the actuator.

13. The token operated access control system of claim 11, wherein the token validator has a token input for receiving a token and a valid token output and an invalid token output in communication with the token input.

14. The token operated access control system of claim 13, wherein the actuating device comprises a switch positioned in alignment with the valid token output, the switch being actuatable by a valid token exiting the valid token output.

15. The token operated access control system of claim 14, wherein the actuator is operable to transition the strike from the latching state to the unlatching state in response to actuation of the switch by a valid token exiting the valid token output.

16. The token operated access control system of claim 11 further comprising a transformer coupled to the actuator for supplying power to the strike to transition the strike between the latching and unlatching states.

17. The token operated access control system of claim 16 further comprising an indicator deadbolt operatively connected to the switch, the indicator deadbolt being movable to a first position in which the switch is enabled so as to be actuatable by a valid token exiting the valid token output to transition the strike from the latching state to the unlatching state and a second position in which the switch is disabled so as not to be actuatable by a valid token exiting the valid token output.

18. The token operated access control system of claim 17 further comprising an indicator operatively connected to the indicator deadbolt, the indicator being operable to provide a visual indication when the indicator deadbolt is moved to the second position.

19. A method of controlling access to a secured area through a door using a token operated access control system, comprising:
providing an electrically-operated access control device having a first state in which the door is secured and a second state in which the door is unsecured, the access control device comprising one of an electrically-operated door lock or an electrically-operated strike;
electrically coupling a token operated actuator to the access control device, with the access control device being located externally of the token operated actuator, the actuator having a token validator including a token input for receiving a token and a single valid token output and a separate single invalid token output both in communication with the token input and an actuating device positioned in alignment with the valid token output, the token validator being configured to distinguish between, and separate, a valid token and an invalid token introduced into the token input of the token validator and passing through the token validator;
receiving a token in the token input of the token validator; and
automatically transitioning the access control device from the first state to the second state via the actuator in response to an electrical signal generated by the actuator resulting from a valid token introduced into the token input of the token validator and detected by the actuating device.

20. The method of claim 19, wherein the electrically-operated door lock has a locked state in which the door is secured and an unlocked state in which the door is unsecured.

21. The method of claim 20, wherein the door lock comprises an electrically-operated cylindrical lockset.

22. The method of claim 20, further comprising the steps of:
electrically coupling the actuator to the door lock; and
transitioning the door lock from the locked state to the unlocked state in response to a valid token introduced into the token validator.

23. The method of claim 19, wherein the electrically-operated strike has a latching state in which the door is secured and an unlatching state in which the door is unsecured.

24. The method of claim 23, further comprising the steps of:
electrically coupling the actuator to the strike; and
transitioning the door strike from the latching state to the unlatching state in response to a valid token introduced into the token validator.
